(19) United States
(12) Patent Application Publication
(10) Pub. No.: US 2002/0051011 A1
(43) Pub. Date: May 2, 2002

(54) Communication type navigation system

(75) Inventor: Shinichiro Goto, Wako-shi (JP)

Correspondence Address: ARENT FOX KINTNER PLOTKIN & KAHN, PLLC, Suite 600, 1050 Connecticut Avenue, N. W., Washington, DC, 20036-5339, US

(73) Assignee: Honda Giken Kogyo Kabushiki Kaisha

(21) Appl. No.: 09/984,269

(22) Filed: Oct. 29, 2001

(30) Foreign Application Priority Data
Oct. 30, 2000 (JP) 2000-331525

(51) Int. Cl. G06F 3/00; G06F 13/00

(52) U.S. Cl. 345/738

(57) ABSTRACT

A communication type navigation system includes an information server provided on the Internet, and a user terminal connected to the information server. The user terminal device includes a display unit which displays information received from the information server; a current position detection unit which detects a current position of the user terminal device; and a communication unit which transmits the current position of the user terminal device to the information server and receives a piece of electronic mail transmitted from the information server. The information server includes an information retrieval unit which performs information retrieval relating to a predetermined area around the current position of the user terminal device; and an electronic mail transmission unit which generates a piece of electronic mail that supplies results of retrieval by the information retrieval unit to the user terminal device and transmits the piece of electronic mail to the user terminal device.

### BACKGROUND OF THE INVENTION

1. Field of the Invention

The present invention relates to a navigation system which may be used in, for example, a navigation device for a vehicle or for a personal digital assistant (PDA). More specifically, the present invention relates to a technique for carrying out information retrieval by means of connecting to a server unit.

2. Description of Related Art

A navigation device for a vehicle is conventionally known which carries out various kinds of information retrieval by connecting to an information server on the Internet.

In this type of navigation device, a user presets such factors as the category of facilities to retrieve and the retrieval interval based on the travel distance of a vehicle and the navigation device automatically connects to an information server to retrieve information.

However, in the above-mentioned navigation device using a conventional technique, since the information to be retrieved is specified in the navigation device side, it is necessary to send the retrieval condition to the information server every time the connection is made and to maintain the connection between the navigation device and the information server from the start of the information retrieval operation to the transmission of the retrieval result to the navigation device. Accordingly, the cost for the connection is increased.

Also, as for the setting for the information retrieval operation, a user can set, for instance, only to carry out a retrieval based on a predetermined travel distance interval, and detailed settings which satisfy various user needs are not yet realized.

### SUMMARY OF THE INVENTION

The present invention takes into consideration the above-mentioned circumstances, and has an object of providing a communication type navigation system which realizes convenient and detailed settings for information retrieval and which is capable of decreasing the communication cost necessary for information retrieval.

The above object may be achieved by a communication type navigation system including: an information server (for instance, an information server 12 in an embodiment described later) which may be provided on the Internet, and a user terminal (for example, a user terminal device 11 in the embodiment described later) communicably connected to the information server, wherein the user terminal device includes: a display unit (for instance, a display unit 21 in the embodiment described later) which displays information received from the information server; a current position detection unit (for instance, a current position detection unit 25 in the embodiment described later) which detects a current position of the user terminal device; and a communication unit (for instance, a communication unit 22 in the embodiment described later) which transmits the current position of the user terminal device to the information server as well as receives a piece of electronic mail transmitted from the information server, and the information server includes: an information retrieval unit (for instance, an information retrieval unit 33 in the embodiment described below) which carries out information retrieval relating to a predetermined area in the vicinity of current position of the user terminal device detected by the current position detection unit; and an electronic mail transmission unit (for instance, a server side electronic mail generation unit 36 in the embodiment described later) which generates a piece of electronic mail that supplies results of retrieval by the information retrieval unit to the user terminal device and which transmits the piece of electronic mail to the user terminal device.

According to the communication type navigation system having the above-mentioned configuration, for instance, a user terminal provided in a movable object, such as a vehicle, transmits position information, such as the current position, destination, and travel path, to the information server. Then the information server carries out information retrieval, based on the received position information, around the area in the vicinity of a predetermined position. The results of retrieval may be described in a piece of electronic mail and be stored in a piece of electronic mail server, or may be described in a suitable Web page and stored in an HTTP server. Also, a piece of electronic mail in which an address of the Web page or link information is described is generated and is stored in the electronic mail server. After this, a new piece of electronic mail which is stored in the electronic mail server is transmitted to the user terminal device when, for example, the user again connects to the information server.

Accordingly, connection between the user terminal device and the information server is required only for a period of time corresponding to the transmission of position information from the user terminal device to the information server and the transmission of information relating to the retrieval results from the information server to the user terminal device. Accordingly, it becomes possible to decrease the cost of communication by shortening the time connected to the circuit.

In accordance with another aspect of the invention, the user terminal device makes connection to the information server at a predetermined time interval.

According to the communication type navigation system having the above-mentioned configuration, even if the travel distance of the user terminal device is short, such as in the case of rush-hour traffic, a new piece of electronic mail may be reliably received by making periodic connection to the information server.

In accordance with another aspect of the invention, the user terminal device makes connection to the information server at a predetermined time.

According to the communication type navigation system having the above-mentioned configuration, it becomes possible to confirm whether a new piece of electronic mail has arrived by making connection to the information server at a certain predetermined time.

In accordance with another aspect of the invention, the user terminal device makes connection to the information server when reaching the vicinity of a predetermined position.

According to the communication type navigation system having the above-mentioned configuration, it becomes possible to determine whether a new piece of electronic mail has arrived by making connection to the information server when reaching the vicinity of a predetermined position, such as a destination, a transit or an intersection.

In accordance with another aspect of the invention, a communication type navigation system of the invention further includes a retrieval condition setting unit (for instance, a control unit 26 in an embodiment described below) which is capable of setting retrieval conditions for the information retrieval in the information server and storing the retrieval conditions in the information server.

According to the communication type navigation system having the above-mentioned configuration, since the retrieval conditions are stored in the information server side, it becomes possible to shorten the communication time via the line connection as compared to a case where the retrieval conditions are transmitted to the information server from the user terminal device every time a start of the information retrieval is ordered. Accordingly, the cost required for communication may be further decreased.

### BRIEF DESCRIPTION OF THE DRAWINGS

Some of the features and advantages of the invention having been described, others will become apparent from the detailed description which follows, and from the accompanying drawings, in which:

FIG. 1 is a block diagram showing the structure of a communication type navigation system according to an embodiment of the present invention;

FIGS. 2A and 2B are diagrams showing examples of a display screen which can be displayed by a display unit of a user terminal device; FIGS. 3A and 3B are diagrams showing other examples of the display screen which can be displayed by the display unit of the user terminal device;

FIGS. 4A through 4G are diagrams showing examples of display screens of the display unit of the user terminal device during an automatic communication mode in which time interval for automatic communication is set;

FIG. 5 is a diagram showing a flow of various information in the communication type navigation system when automatic vicinity retrieval is in the ON state;

FIG. 6 is a diagram showing a flow of various information in the communication type navigation system when automatic vicinity retrieval is in the OFF state;

FIGS. 7A and 7B are diagrams showing examples of a display screen of the display unit of the user terminal device when there is a new information obtained via the automatic communication;

FIGS. 8A and 8B are diagrams showing examples of a display screen of the display unit of the user terminal device showing retrieval results of automatic vicinity retrieval; and

FIG. 9 is a diagram showing a flow of various information in the communication type navigation system when a self-position notification service is in the ON state.

### DETAILED DESCRIPTION OF THE INVENTION

The invention summarized above and defined by the enumerated claims may be better understood by referring to the following detailed description, which should be read with reference to the accompanying drawings. This detailed description of a particular preferred embodiment, set out below to enable one to build and use one particular implementation of the invention, is not intended to limit the enumerated claims, but merely to serve as one example of the invention.

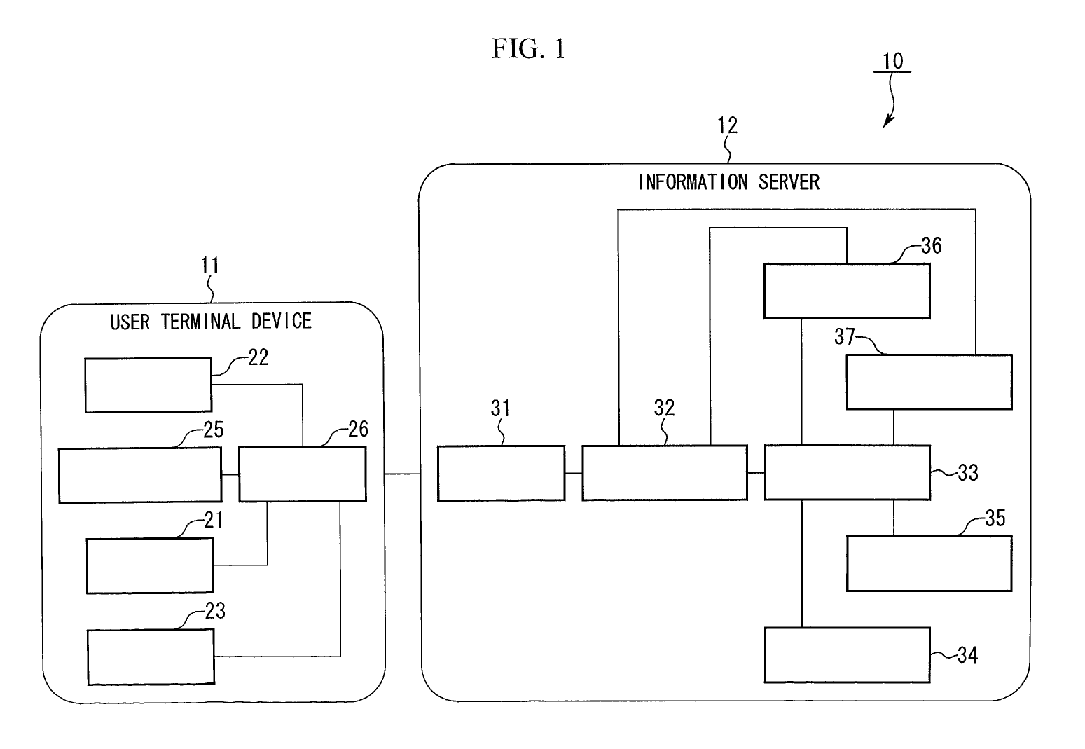

FIG. 1 is a block diagram showing the structure of a communication type navigation system 10 according to an embodiment of the present invention. The communication type navigation system 10 according to this embodiment of the invention includes a user terminal device 11 and an information server 12.

The user terminal device 11 may be a navigation device or a computer device, which is connected to the information server 12 on the Internet via, for instance, a portable terminal or a communication device owned by a user, or a PDA. The user terminal device 11 may include a display unit 21, a communication unit 22, an input unit 23, a current position detection unit 25, and a control unit 26.

The display unit 21, as will be described below, displays various information such as retrieval results transmitted from the information server 12.

The communication unit 22 may be a portable terminal, for instance, a portable telephone, carried by a user (a passenger), and it is connected to the information server 12 to be able to communicate therewith. The communication unit 22 may transmit data, such as information on the current position of a vehicle or retrieval order around the current position based on predetermined conditions, or receive data, such as retrieval results, from the information server 12.

The input unit 23 may be used for such purposes as inputting items relating to the retrieval order.

The current position detection unit 25 computes the current position of a vehicle based on, for instance, localizing signals, such as Global Position System (GPS) signals, which utilizes, for example, satellites, for measuring the position of a vehicle, road traffic information such as Vehicle Information & Communication System (VICS) information, and a process of an auto-navigation unit (not shown in the figures) including an yaw rate sensor, for instance, a gyro sensor, and an accelerometer. The current position detection unit 25 then carries out such processes as map matching for map information stored in, for example, the map information storing unit (not shown in the figures).

The control unit 26, as will be described below, may be used for setting retrieval conditions by connecting to the information server 12, or controlling transmission of, for instance, positional information, such as a current position, a destination, and travel path of a vehicle, and of retrieval order based on predetermined conditions around each position.

The information server 12 may include, for example, a verification unit 31, a navigation server device 32, an information retrieval unit 33, a retrieved information storing unit 34, a user information storing unit 35, a server side electronic mail generation unit 36, and a HTML generation unit 37.

The verification unit 31 may be a connection interface, such as a Common Gateway Interface (CGI), and carries out a verification operation for an access from, for instance, the user terminal device 11.

The navigation server device 32 supplies, for instance, map information for navigation, route information, and road traffic information, and includes an electronic mail server, a Hyper Text Transfer Protocol (HTTP) server, and an external program server, such as an applet server, which incorporates additional functions into a Web page made of text files written by Hyper Text Markup Languages (HTML), image data, etc.

The information retrieval unit 33 retrieves information stored in the retrieved information storing unit 34 for, for instance, the vicinity of the current position of a vehicle, based on the retrieval order transmitted from the user terminal device 11.

The user information storing unit 35 stores information relating to a user of the user terminal device 11, such as shopping information or areas of interest information registered by the user, as well as information relating to delivery destination, for example, addresses of electronic mail, so that positional information, such as the current position of a vehicle, a destination, and travel, which is transmitted from the user terminal device 11, may be delivered to other users.

The server side electronic mail generation unit 36 generates a piece of electronic mail, in which the results of retrieval by the information retrieval unit 33, the addresses of Web pages including the retrieval results, etc., are described, and transfers the piece of electronic mail to the electronic mail server of the navigation server device 32.

The HTML generation unit 37 generates a Web page, in which the retrieval results by the information retrieval unit 33 are described, and transfers the Web page to the HTTP server of the navigation server device 32.

Next, operation of the communication type navigation system 10 according to an embodiment of the present invention having the above-explained structure will be explained with reference to the accompanying drawings.

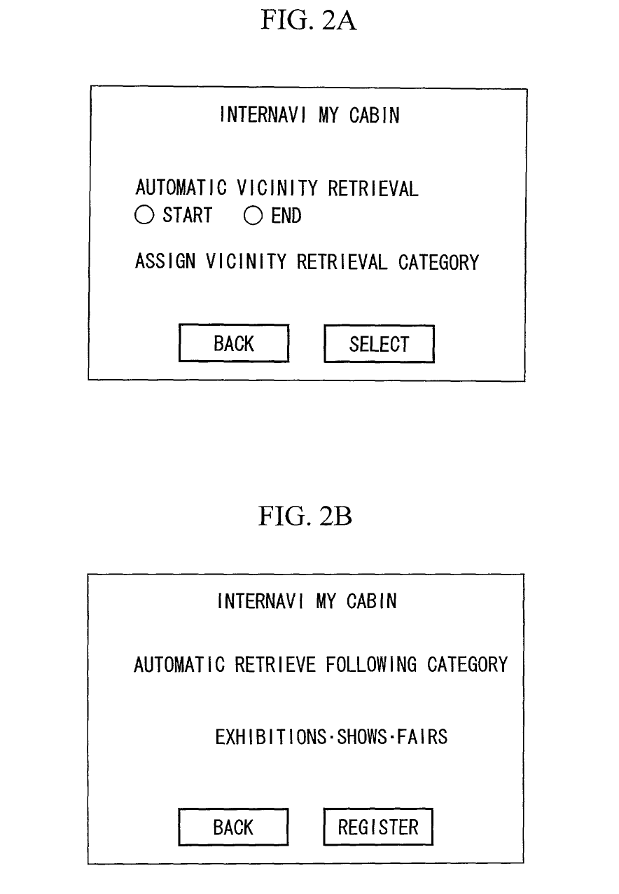

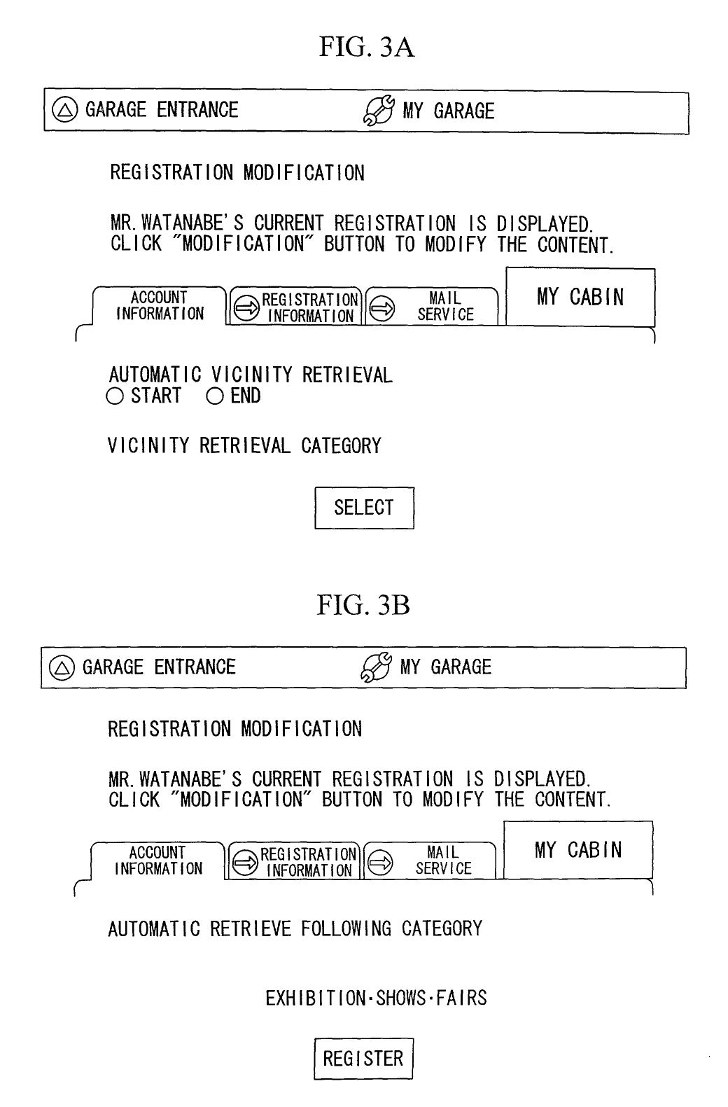

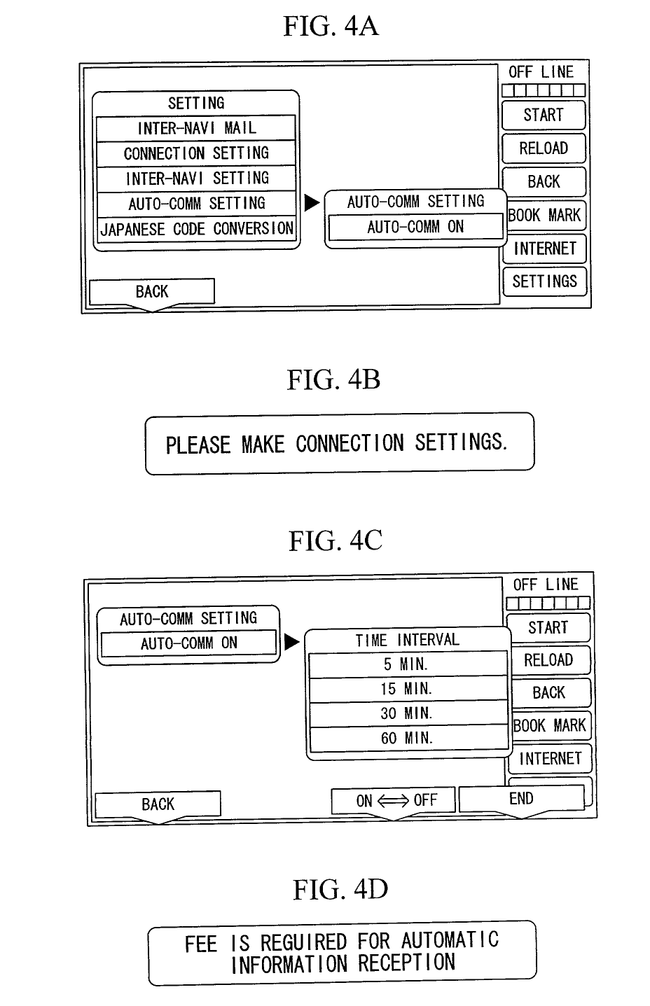

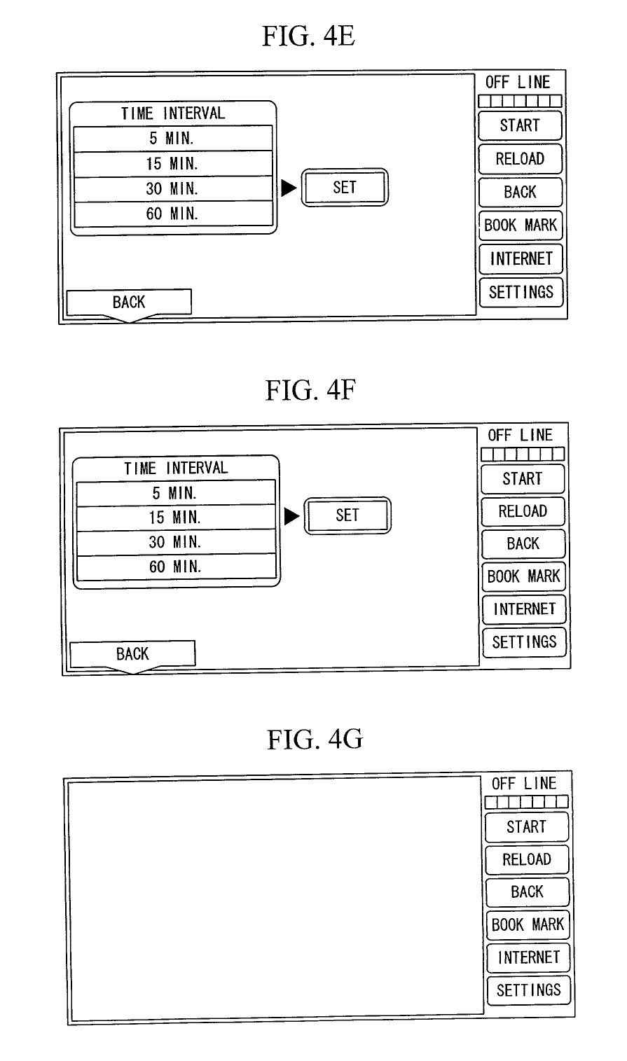

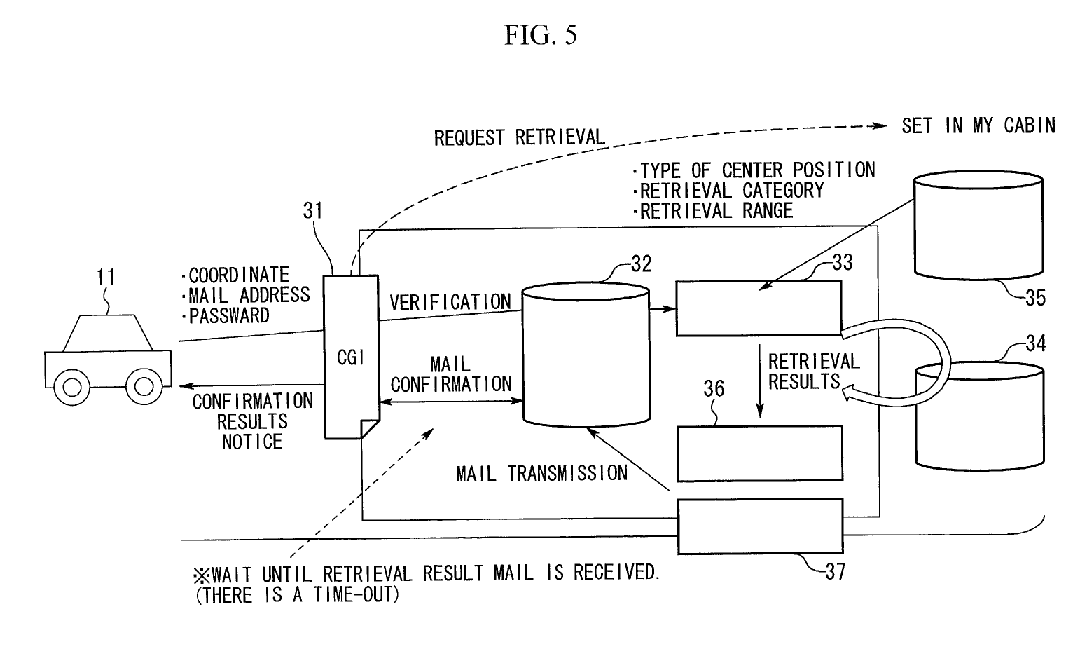

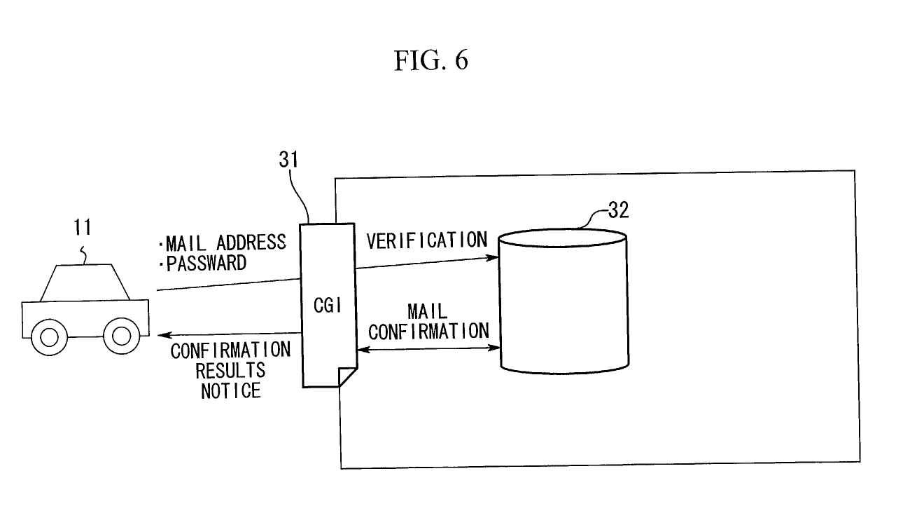

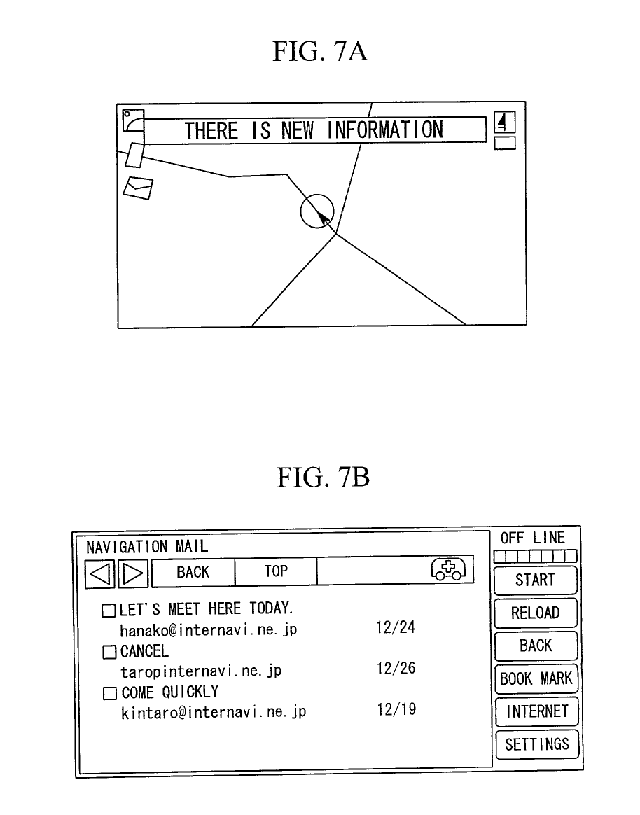

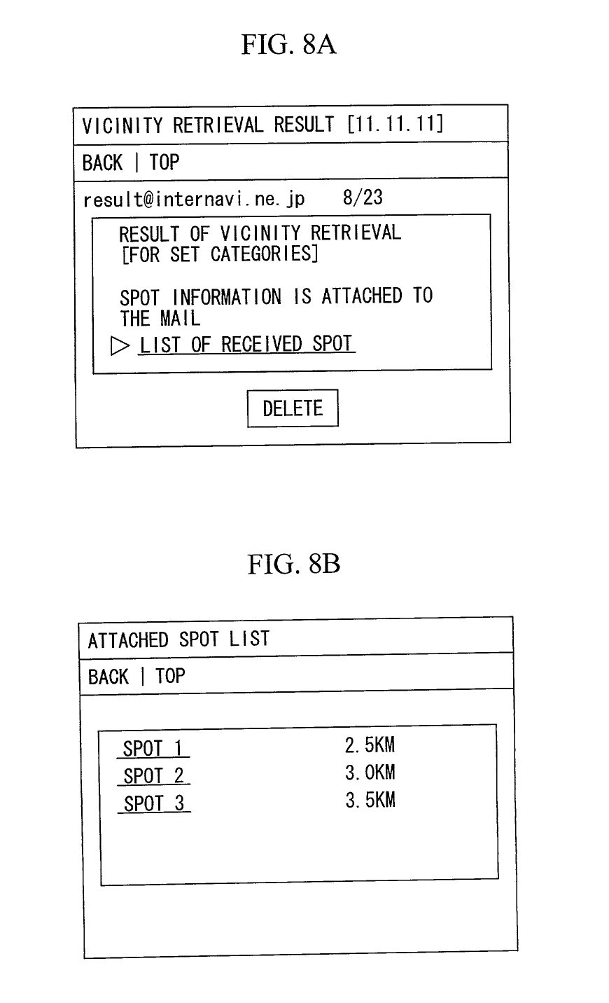

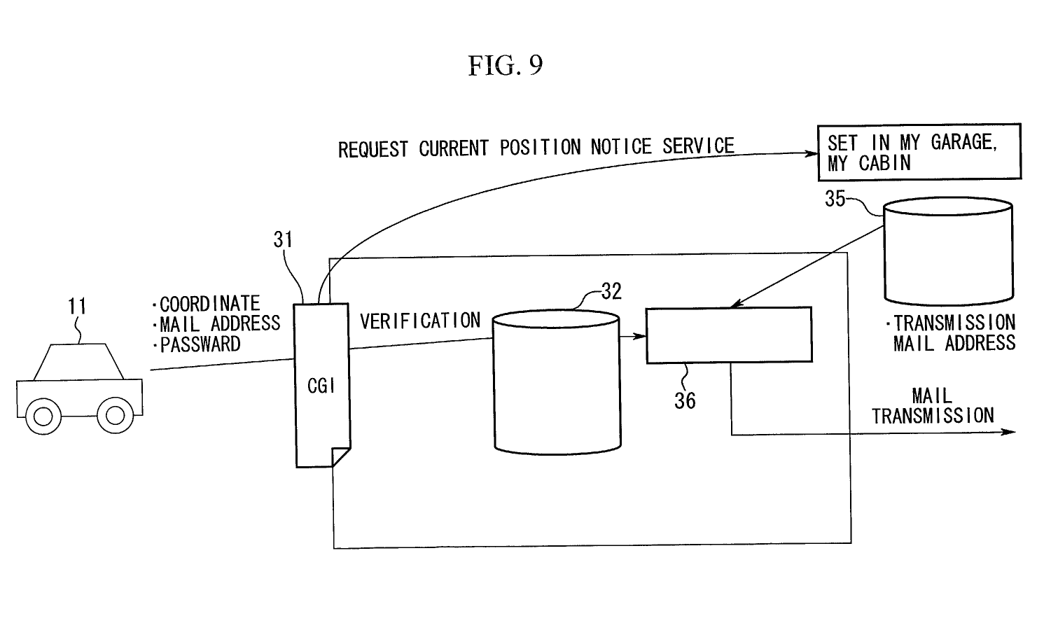

FIGS. 2A and 2B are diagrams showing examples of a display screen which can be displayed by the display unit 21 of the user terminal device 11. FIGS. 3A and 3B are diagrams showing other examples of the display screen which can be displayed by the display unit 21 of the user terminal device 11. FIGS. 4A through 4G are diagrams showing examples of display screens of the display unit 21 of the user terminal device 11 during an automatic communication mode in which time intervals for automatic communication are set. FIG. 5 is a diagram showing a flow of various information in the communication type navigation system 10 when automatic vicinity retrieval is in the ON state. FIG. 6 is a diagram showing a flow of various information in the communication type navigation system 10 when automatic vicinity retrieval is in the OFF state. FIGS. 7A and 7B are diagrams showing examples of a display screen of the display unit 21 of the user terminal device 11 when there is new information obtained by the automatic communication. FIGS. 8A and 8B are diagrams showing examples of a display screen of the display unit 21 of the user terminal device 11 showing retrieval results of the automatic vicinity retrieval. FIG. 9 is a diagram showing the flow of various information in the communication type navigation system 10 when a self-position notification service is in the ON state.

In the following, explanation is made for a case where the user terminal device 11 is a navigation device installed in a vehicle.

First, operations for setting various settings for the automatic vicinity retrieval will be explained.

A user makes access to the information server 12 on the Internet from the user terminal device 11 and sets a start or termination of the automatic vicinity retrieval. In this embodiment, the automatic vicinity retrieval is to carry out an information retrieval based on predetermined retrieval conditions within a predetermined peripheral area with respect to the current position information of a vehicle transmitted from the user terminal device 11. As will be described later, according to the automatic vicinity retrieval, a retrieval operation is automatically carried out, for instance, based on the same retrieval conditions at predetermined time intervals.

In the case explained above, information relating to settings of a start or termination of the automatic vicinity retrieval and to settings of retrieval conditions are displayed on the display unit 21 of the user terminal device 11 as shown in FIGS. 2A and 2b.

Note that as the user terminal device 11 for setting a start or termination of the automatic vicinity retrieval, one which is not portable, such as a home computer device, may also be utilized. For instance, any computer device capable of using a predetermined Web browser may be employed, and the computer device may be connected to the HTTP server of the navigation server device 32 to display a Web page for example, one shown in FIGS. 3A and 3B, which is used for setting a start or termination of the automatic vicinity retrieval. The Web page, in addition to the settings for a start or termination of the automatic vicinity retrieval and the settings for retrieval conditions, may contain more detailed setting categories.

FIGS. 2B and 3B show examples of a screen which may be displayed after a user selects a start of automatic vicinity retrieval using the screen shown in FIGS. 2A and 3A, respectively. In FIGS. 2B and 3B, a character string by which the start of a retrieval operation is confirmed (for instance, the phrase “Start automatic retrieval for the following categories” shown in FIGS. 2B and 3B) based on retrieval conditions (for example, “Exhibitions, Shows, Fairs” shown in FIGS. 2B and 3B) is displayed on the screen.

On the other hand, in FIGS. 2A and 3A, a character string by which a termination of the retrieval operation is confirmed, such as “Stop automatic retrieval for the following categories” is set to be displayed on the screen which is displayed after a user selects the termination of the automatic vicinity retrieval.

Next, in the screen for confirmation shown in FIG. 2B or 3B, conditions for automatic communication are set if a user selects the registration of automatic vicinity retrieval.

In this embodiment, as shown in FIG. 4A, a screen for setting the automatic communication conditions is displayed on the display unit 21 of the user terminal device 11.

Here, if the information server 12 and the user terminal device 11 which is the object of the automatic vicinity retrieval are in a communicable state, i.e., in a state where settings relating to connection to the information server 12 are completed by setting “Connection Setting” and “Inter-navigation Setting”, and a user selects “Automatic Communication Setting”, a screen for setting detailed conditions is displayed on the display unit 21 as shown in FIG. 4C.

On the other hand, if a user selects the “Automatic Communication Setting” when the settings for the connection to the information server 12 have not been completed, a message which invites a user to set the connection settings is displayed on the screen as shown in FIG. 4B.

On a screen for setting detailed settings shown in FIG. 4C, for instance, windows for selecting ON/OFF of the automatic communication and for selecting time intervals are displayed.

In this embodiment, if a user selects the ON state of the automatic communication and moves to a step for selecting time intervals, a screen for selecting a desired time interval from a predetermined plurality number of time interval choices (for instance, 5, 15, 30, and 60 minutes) is displayed as shown in FIGS. 4E and 4F.

When a user selects a desired time interval (for instance 30 min. in the selection screen shown in FIG. 4E and 15 min. in the selection screen shown in FIG. 4C) in the selection screens shown in FIGS. 4E and 4F, the screen for setting detailed conditions as shown in FIG. 4C is displayed again.

In this embodiment, when the user selects a termination of the setting operation, a confirmation message relating to a communication fee is displayed as shown in FIG. 4D, and then a normal display screen, for instance, one shown in FIG. 4G is displayed.

Next, operation of the communication type navigation system 10 based on the above-mentioned setting conditions will be explained.

First, as shown in FIG. 5, the user terminal device 11 which is mounted, for instance, in a vehicle is connected to the information server 12 at a predetermined time interval set by a user as shown in FIG. 5. At that time, the user terminal device 11 transmits a user ID which is preregistered for each user, password, and positional information, such as current position information, via a communication protocol, such as HTTP.

Then, the verification unit 31 of the information server 12 carries out a verification operation based on the user ID and the password received, and after confirming the user, transfers the information received to the navigation server device 32.

The navigation server device 32 sends the retrieval conditions and the current position information to the information retrieval unit 33.

The information retrieval unit 33 retrieves retrieved information stored in the retrieved information storing unit 34 based on the retrieval conditions and the current position information received.

Results obtained by the retrieval operation may be transmitted to, for instance, the server side electronic mail generation unit 36 and be stored in a piece of electronic mail server (not shown in figures) of the navigation server device 32 as a piece of electronic mail in which the retrieval results are described, or may be transmitted to the HTML generation unit 37 and be stored in an HTTP server (not shown in figures) of the navigation server device 32 as a Web page in which the retrieval results are described.

Note that if the Web page in which the retrieval results are described is generated, a piece of electronic mail in which the address of the Web page or link information is written is generated by the server side electronic mail generation unit 36, and is stored in an electronic mail server (not shown in the figures) of the navigation server device 32.

Then, the piece of electronic mail stored in the electronic mail server of the navigation server device 32 is transmitted to the user terminal device 11 via the verification unit 31.

The connection between the user terminal device 11 and the navigation server device 32 is disconnected, for instance, when a certain predetermined time has elapsed since the user terminal device 22 is connected to the navigation server device 32 and positional information is transmitted from the user terminal device 11, or when a piece of electronic mail is transmitted to the user terminal device 11 from the electronic mail server of the navigation server device 32.

Note that if the termination of the automatic vicinity retrieval has been set, the line connection is disconnected, for instance, as indicated in FIG. 6, after the user terminal device 11 confirms whether a new piece of electronic mail is stored in the electronic mail server of the navigation server device 32.

If a new piece of electronic mail is transmitted to the user terminal device 11 from the electronic mail server of the navigation server device 32, a message notifying the reception of the new piece of electronic mail may be displayed on the screen as shown in FIG. 7A, or a suitable indication is made on a predetermined position of the display screen.

Then, as shown in FIG. 7B, a list of pieces of electronic mail received is displayed on the screen.

Also, the content of each piece of electronic mail may be categorized as lists of different retrieval area as shown in FIGS. 8A and 8B.

Note that when address information or link information of the Web page in which the retrieval results are described is written in a piece of electronic mail, the user terminal device 11 is connected again to the navigation server device 32 when the user selects the address information or the link information, and the predetermined Web page which is stored in the HTTP server of the navigation server device 32 is displayed.

As mentioned above, according to the embodiment of the communication type navigation system 10 of the invention, the connection between the user terminal device 11 and the information server 12 is required only for a period of time corresponding to the transmission of position information from the user terminal device 11 to the information server 12 and the transmission of information relating to the retrieval results from the information server 12 to the user terminal device 11. Accordingly, it becomes possible to decrease the cost required for the communication by shortening the time for communication via the line connection.

Moreover, since the user terminal device 11 is connected to the information server 12 at a certain time interval, a new piece of electronic mail may be reliably received, even if the travel distance of the user terminal device 11 is short, due to the periodical connection to the information server 12.

Furthermore, if the retrieval conditions are stored in the information server 12 side, it becomes possible to shorten the communication time as compared to a case where the retrieval conditions are transmitted to the information server 12 from the user terminal device 11 every time a start of the information retrieval is commanded. Accordingly, the cost required for communication may further be decreased.

Note that although the user terminal device 11 makes connection to the information server 12 at a predetermined certain time interval in order to transmit the current position information of a vehicle and to receive the results of periphery retrieval as a piece of electronic mail in the above-explained embodiment, it is not so limited, and as shown in FIG. 9, it is possible to send a piece of electronic mail, in which the current position information of the vehicle is written, to other predetermined users.

In the electronic mail to be sent, address information or link information of a suitable Web page, in which the current position of a vehicle (of the user) is indicated on the map, may be described. Also, a map image around the current position of a vehicle may be attached to the piece of electronic mail.

Although the information retrieval unit 33 retrieves the retrieved information stored in the retrieved information storing unit 34 based on the retrieval conditions and the current position information received in the above-mentioned embodiment, this is not so limited, and it is possible, for instance, to set a retrieval condition based on information stored in the user information storing unit 35.

Also, although the time interval for connection between the user terminal device 11 and the information server 12 is set when the automatic vicinity retrieval conditions are set in the above-explained embodiment, this is not so limited, and it is possible, for instance, to obtain a predetermined external program, which may be stored in an external program server (not shown in the figures) and so forth provided with the information server 12, and utilize, or modify if necessary, the external program to enable setting for more detailed settings, such as assignment for time and day to carry out automatic vicinity retrieval or retrieval conditions.

Moreover, although the user terminal device 11 is connected to the information server 12 at each certain time interval in the above-mentioned embodiment, it is not limited as such, and it is possible to make connection to the information server 12, for instance, at a predetermined time, or when approaching the vicinity of a predetermined destination, travel path, or landmarks such as an intersection.

Having thus described several exemplary embodiments of the invention, it will be apparent that various alterations, modifications, and improvements will readily occur to those skilled in the art. Such alterations, modifications, and improvements, though not expressly described above, are nonetheless intended and are implied to be within the spirit and scope of the invention. Accordingly, the invention is limited and defined only by the following claims and equivalents thereto.

1. A communication type navigation system, comprising:
an information server provided on the Internet, and
a user terminal device communicably connected to said information server, wherein
said user terminal device comprises:
a display unit which displays information received from said information server;
a current position detection unit which detects a current position of said user terminal device; and
a communication unit which transmits the current position of said user terminal device to said information server as well as receives a piece of electronic mail transmitted from said information server, and
said information server comprises:
an information retrieval unit which carries out information retrieval relating to a predetermined area in the vicinity of the current position of said user terminal device detected by said current position detection unit; and
an electronic mail transmission unit which generates a piece of electronic mail that supplies results of retrieval by said information retrieval unit to said user terminal device and which transmits said piece of electronic mail to said user terminal device.

2. A communication type navigation system according to claim 1, wherein
said user terminal device makes connection to said information server at a predetermined time interval.

3. A communication type navigation system according to claim 1, wherein
said user terminal device makes connection to said information server at a predetermined time.

4. A communication type navigation system according to claim 1, wherein
said user terminal device makes connection to said information server when reaching the vicinity of a predetermined location.

5. A communication type navigation system according to claim 1, further comprising:
a retrieval condition setting unit which is capable of setting retrieval conditions for information retrieval in said information server.

6. A communication type navigation system according to claim 2, further comprising:
a retrieval condition setting unit which is capable of setting retrieval conditions for information retrieval in said information server.

7. A communication type navigation system according to claim 3, further comprising:
a retrieval condition setting unit which is capable of setting retrieval conditions for information retrieval in said information server.

8. A communication type navigation system according to claim 4, further comprising:
a retrieval condition setting unit which is capable of setting retrieval conditions for information retrieval in said information server.
